(19) United States
(12) Patent Application Publication
(10) Pub. No.: US 2021/0333490 A1
(43) Pub. Date: Oct. 28, 2021

(54) METHOD OF BONDING FOCUSING LENS WITH FIBER ARRAY AND METHOD OF ALIGNING THE SAME

(71) Applicant: Prime World International Holdings Ltd., New Taipei City (TW)

(72) Inventor: Cheng-Te PENG, New Taipei City (TW)

(21) Appl. No.: 16/858,009

(22) Filed: Apr. 24, 2020

(51) Int. Cl. G02B 6/42

(52) U.S. Cl. CPC G02B 6/4204; G02B 6/4242

(57) ABSTRACT

A method of bonding a focusing lens with a fiber array is disclosed. A core end facet of a first optical fiber disposed on the fiber array is recognized by a camera. A projection of the core end facet of the first optical fiber on a bonding surface of the fiber array is specified by a processing unit to obtain a core end facet information. An alignment procedure is performed by a pickup component according to the core end facet information to make an optical axis of the focusing lens overlap with the projection of the core end facet of the first optical fiber. The focusing lens is attached to the bonding surface of the fiber array.

### TECHNICAL FIELD

The present disclosure relates to a bonding method and an alignment method, more particularly to a method of bonding a focusing lens with a fiber array, and a method of aligning the focusing lens with the fiber array during bonding process.

### BACKGROUND

Optical transceivers are generally installed in electronic communication facilities in modern high-speed communication networks. In order to make flexible the design of an electronic communication facility and less burdensome the maintenance of the same, an optical transceiver is inserted into a corresponding cage that is disposed in the communication facility in a pluggable manner. In order to define the electrical-to-mechanical interface of the optical transceiver and the corresponding cage, different specifications such as XFP (10 Gigabit Small Form Factor Pluggable) used in 10 GB/s communication rate, QSFP (Quad Small Form-factor Pluggable), or other form factors at different communication rates have been made available.

With the development of technology, a high-speed optical transceiver, such as 400 G, has been utilized to meet the demand of higher communication speed. The communication speed of the optical transceiver is usually determined by the bandwidth for signal transmission, where a spot size of light may correlate to any achievable bandwidth.

### SUMMARY

According to one aspect of the present disclosure, a method of bonding a focusing lens with a fiber array is disclosed. Such disclosed method in one embodiment includes: recognizing a core end facet of a first optical fiber disposed on the fiber array by a camera, specifying a projection of the core end facet of the first optical fiber on a bonding surface of the fiber array by a processing unit to obtain a core end facet information, performing an alignment procedure by a pickup component according to the core end facet information to make an optical axis of the focusing lens overlap with the projection of the core end facet of the first optical fiber, and attaching the focusing lens to the bonding surface of the fiber array.

According to another aspect of the present disclosure, a method of aligning a focusing lens with a fiber array is disclosed. Such disclosed method in one embodiment includes: recognizing a core end facet of an optical fiber disposed on the fiber array by a camera, specifying a projection of the core end facet of the optical fiber on a bonding surface of the fiber array by a processing unit to obtain a core end facet information, and performing an alignment procedure by a pickup component according to the core end facet information to make an optical axis of the focusing lens overlap with the projection of the core end facet of the optical fiber.

### BRIEF DESCRIPTION OF THE DRAWINGS

The present disclosure will become more fully understood from the detailed description given below and the accompanying drawings which are given by way of illustration only and thus are not intending to limit the present disclosure and wherein:

FIG. 1 is a schematic view of an apparatus for bonding a focusing lens with a fiber array, according to one embodiment of the present disclosure;

FIG. 2A is a perspective view of the fiber array and the focusing lens according to a first embodiment of the present disclosure;

FIG. 2B is a flow chart of a method of bonding the focusing lens with the fiber array according to the first embodiment of the present disclosure;

FIG. 2C to FIG. 2E are schematic views of bonding the focusing lens with the fiber array in FIG. 2A by using the apparatus in FIG. 1;

FIG. 3A is a perspective view of a fiber array and a focusing lens according to a second embodiment of the present disclosure;

FIG. 3B is a flow chart of an alignment procedure according to the second embodiment of the present disclosure; and

FIG. 3C to FIG. 3F are schematic views of bonding the focusing lens in FIG. 3A with a fiber array by using the apparatus in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

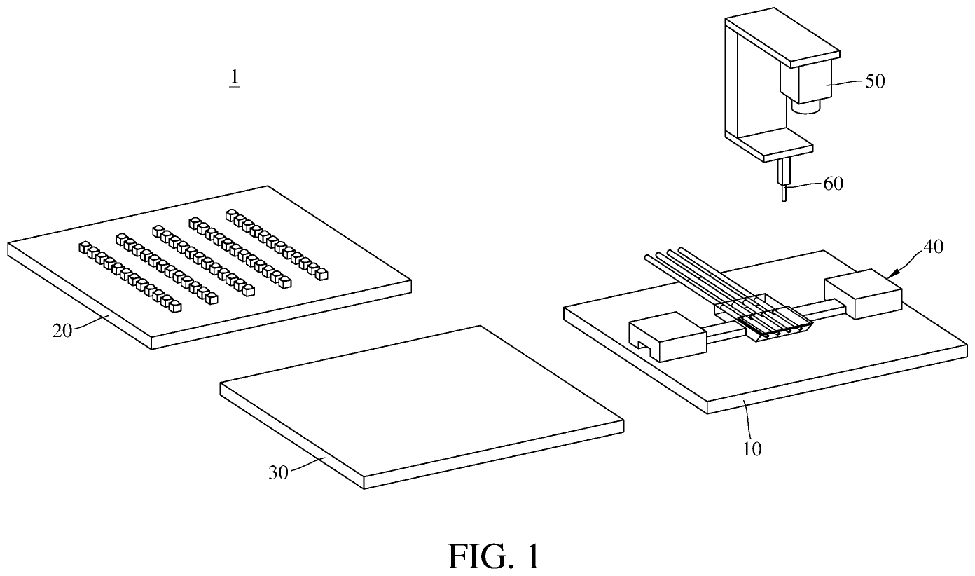

FIG. 1 is a schematic view of an apparatus for bonding a focusing lens with a fiber array, according to one embodiment of the present disclosure. In one embodiment, an apparatus 1 includes a first stage 10, a second stage 20, a third stage 30, a fixture 40, a camera 50 and a pickup component 60.

The first stage 10 is configured to support a fiber array and includes an alignment mark 100. The second stage 20 is configured to support a focusing lens. The third stage 30 is configured to be a working region for aligning the focusing lens with the fiber array, and the third stage 30 includes an alignment mark 300. The fixture 40 is configured to position the fiber array. The camera 50 is movable between the first stage 10 and the third stage 30 and configured to capture an image of the fiber array or the focusing lens. The pickup component 60 is movable among the first stage 10 through the third stage 30 and configured to physically capture the focusing lens.

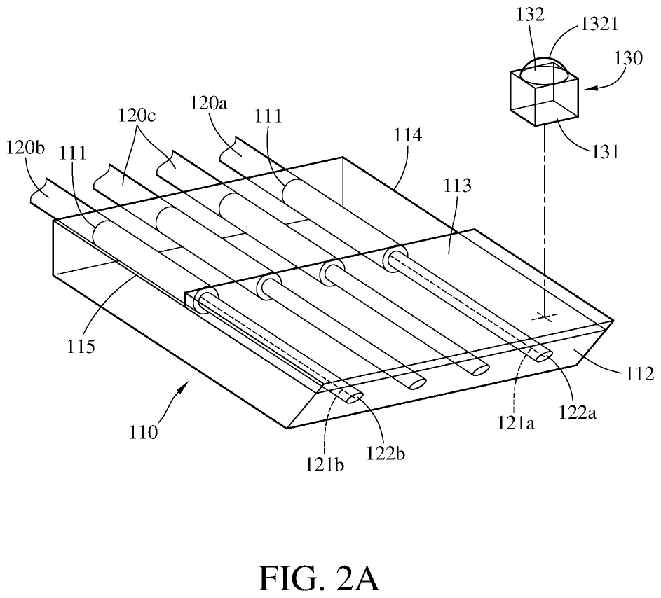

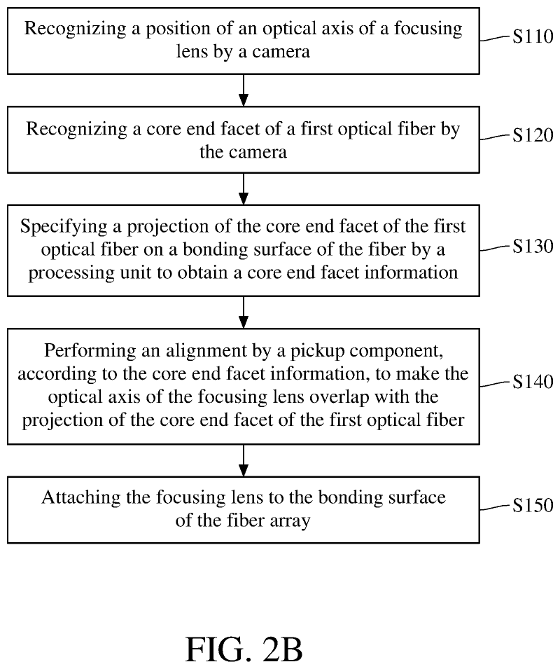

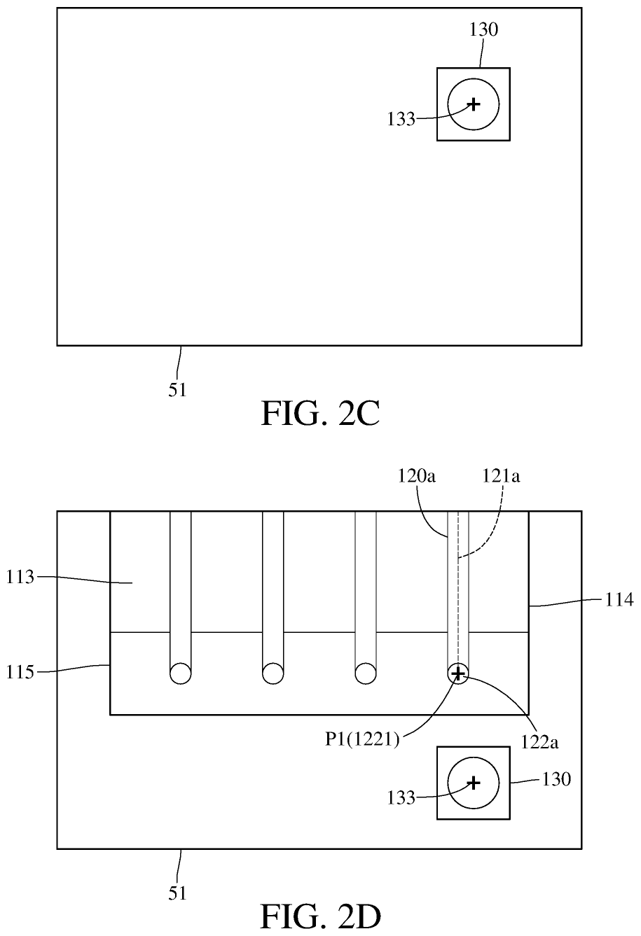

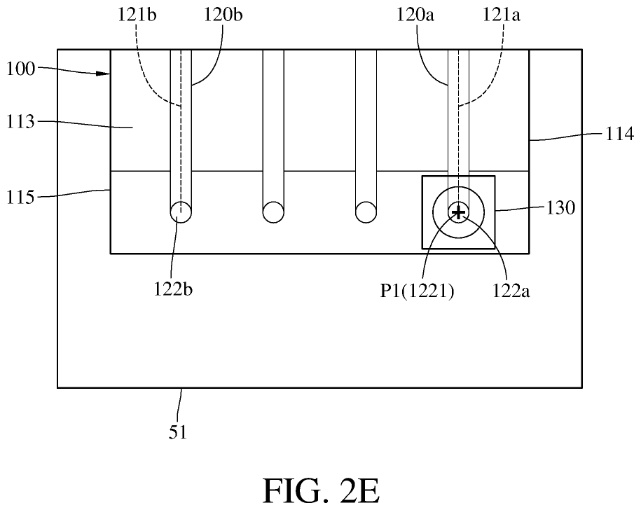

Details of the fiber array and the focusing lens are described as follows. FIG. 2A is a perspective view of the fiber array and the focusing lens according to a first embodiment of the present disclosure. A fiber array 110 includes an upper portion and a lower portion which are attached together to from multiple holes 111 therebetween. Multiple optical fibers are inserted into the holes 111, respectively. Each optical fiber includes a cladding and a core covered by the cladding, and a core end facet of the optical fiber is, for example, a 42.5 degrees end facet flush with an inclined sidewall 112 of the fiber array 110, and the core end facet is exposed to outside. A bonding surface 113 of the fiber array 110 is connected to the inclined sidewall 112, and the bonding surface 113 is the bottom surface of the fiber array 110.

In this embodiment, the optical fibers disposed on the fiber array 110 include a first optical fiber 120a, a second optical fiber 120b and multiple third optical fibers 120c. The first optical fiber 120a is an optical fiber closest to the left edge 114 of the fiber array 110, and the second optical fiber 120b is an optical fiber closest to the right edge 115 of the fiber array 110. The third optical fibers 120c are arranged between the first optical fiber 120a and the second optical fiber 120b. As shown in FIG. 2A, the optical fiber 120a, the second optical fiber 120b and the third optical fibers 120c are all optical fibers disposed on the fiber array 110. Both a core 121a of the first optical fiber 120a and a core 121b of the second optical fiber 120b are spaced apart from the periphery of the fiber array 110.

A focusing lens 130, for example, is a singlet lens including a bar 131 and a lens 132 attached to each other. A convex surface 1321 of the lens 132 is located opposite to where the bar 131 connects to the bonding surface 113. The refractive index of the focusing lens 130 is larger than the refractive index of the fiber array 110. Specifically, the refractive index of the focusing lens 130 is 3.5 in this embodiment.

In the first embodiment, a method of bonding the focusing lens 130 with the fiber array 110 is disclosed as follows. FIG. 2B is a flow chart of a method of bonding the focusing lens with the fiber array according to the first embodiment of the present disclosure. FIG. 2C to FIG. 2E are schematic views of bonding the focusing lens with the fiber array in FIG. 2A by using the apparatus in FIG. 1. In this embodiment, the method of bonding the focusing lens 130 with the fiber array 110 includes steps S110 through S150. The fiber array 110 with the optical fibers is supported on the first stage 10 of the apparatus 1 and clamped by the fixture 40.

In the step S110, a position of an optical axis 133 of the focusing lens 130 is recognized by the camera 50. As shown in FIG. 1 and FIG. 2C, the focusing lens 130 is moved from the second stage 20 to the third stage 30 by, for example, a robotic arm. The camera 50 and the pickup component 60 are also moved to the third stage 30. Then, the camera 50 recognizes the optical axis 133, and the pickup component 60 is configured to capture the focusing lens 130 and move it from the third stage 30 to the first stage 10 where the fiber array 110 is located.

In one embodiment, the pickup component 60 is a suction nozzle which is able to precisely sucks a position on the surface convex surface 1321 corresponding to the optical axis 133 without damaging or tilting the focusing lens 130. In another embodiment, the pickup component 60 is a clamp tool or a tweezer.

In the step S120, a core end facet 122a of the first optical fiber 122, disposed on the fiber array 110, is recognized by the camera 50. As shown in FIG. 1 and FIG. 2D, the camera 50 and the pickup component 60 is moved from the third stage 30 to the above of the first stage 10 with the pickup component 60 holding the focusing lens 130. Then, the camera 50 recognizes the core end facet 122a of the first optical fiber 120a.

In the step S130, a projection P1 of the core end facet 122a of the first optical fiber 120 on the bonding surface 113 of the fiber array 110 is specified by a processing unit (not shown in the drawings) to obtain a core end facet information. In one embodiment, the position of the projection P1 on the bonding surface 113 is specified with a first core pair of reference coordinates; that is, the core end facet information includes the first core pair of reference coordinates. The first core pair of reference coordinates can be stored in a storage medium or marked on a display showing an image 51 of the camera 50.

The processing unit is any device in a computer or network that handles intermediate stage. For example, the processing unit may be a central processing unit (CPU), a motherboard or an image processing software. The storage medium is a device or a material used to place, keep and retrieve electronic data. It refers to a physical device or component in a computing system that receives and retains information relating to applications and users, such as hard disk drive or solid-state drive.

In one embodiment, the first core pair of reference coordinates corresponds to a center 1221 of the core end facet 122a of the first optical fiber 120a. In detail, the position of the core end facet 122a is interpreted as the center 1221 of the core end facet 122a of the first optical fiber 120a.

In the step S140, an alignment procedure is performed by the pickup component 60 according to the core end facet information to make the optical axis 133 of the focusing lens 130 overlap with the projection P of the core end facet 122a of the first optical fiber 120a. As shown in FIG. 2E, when the position of the core end facet 122a is determined, the processing unit is configured to check whether the center 1221 of the core end facet 122a overlaps with the optical axis 133. In one embodiment, the processing unit may check whether the center 1221 of the core end facet 122a and the optical axis 133 has identical pair of reference coordinates. Once there is a deviation between the center 1221 of the core end facet 122a and the optical axis 133, the pickup component 60 is moved to bring the focusing lens 130 towards the core end facet 122a, thereby making the center 1221 of the core end facet 122a overlap with the optical axis 133. In the alignment procedure, the optical axis 133 of the focusing lens 130 is parallel to a normal direction of the bonding surface 113 of the fiber array 110 for preventing misalignment due to tilt of the focusing lens 130.

In the step S150, the focusing lens 130 is attached to the bonding surface 113 of the fiber array 110. In detail, ultra violet (UV) glue is dispersed on either the bonding surface 113 of the fiber array 110 or the focusing lens 130, and the focusing lens 130 is firmly attached to the bonding surface 113 by UV curing. It is worth noting that the attachment of the focusing lens 130 to the fiber array 110 by UV curing in the present disclosure is not limited by the above. In some other embodiments, the focusing lens is attached to the fiber array by heating.

The fiber array 110 bonded with the focusing lens 130 is used as an optical component in an optical transceiver. When light in the first optical fiber 120a is reflected by the core end facet 122a and passes through the focusing lens 130, the light converges to a spot to be received by an optical receiver. The focusing lens 130 is for reducing a spot size of light, thereby improving coupling efficiency to meet the demand of high communication speed.

Traditionally, the alignment of the focusing lens 130 with the fiber array 110 is performed according to the corner, the left edge 114 or the right edge 115 of the fiber array 110. For example, the optical axis 133 of the focusing lens 130 is firstly aligned with the left edge 114. Then, the focusing lens 130 is moved again by a calculated distance between the left edge 114 and the core 121a of the first optical fiber 120a on the core end facet 122a.

In the first embodiment, the alignment of the focusing lens 130 with the fiber array 110 is performed according to the projection of the core end facet 122a of the first optical fiber 120a on the bonding surface 113 (the core end facet information; more specifically, the first core pair of reference coordinates). Thus, the alignment is accomplished by executing only one movement of the focusing lens 130, thereby resulting in better accuracy of alignment compared to the traditional approach.

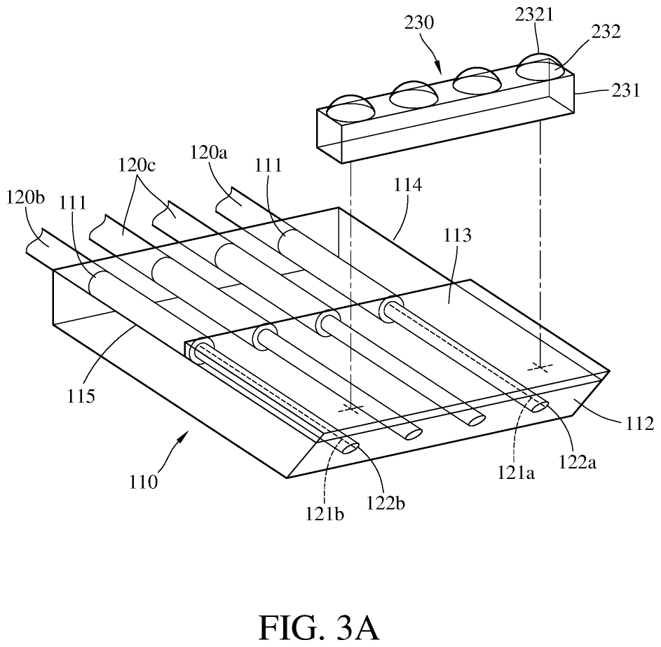

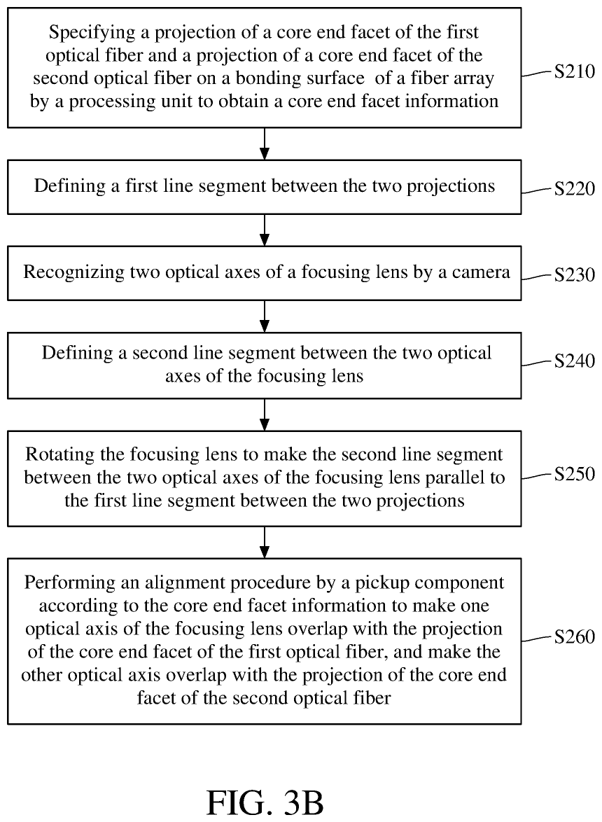

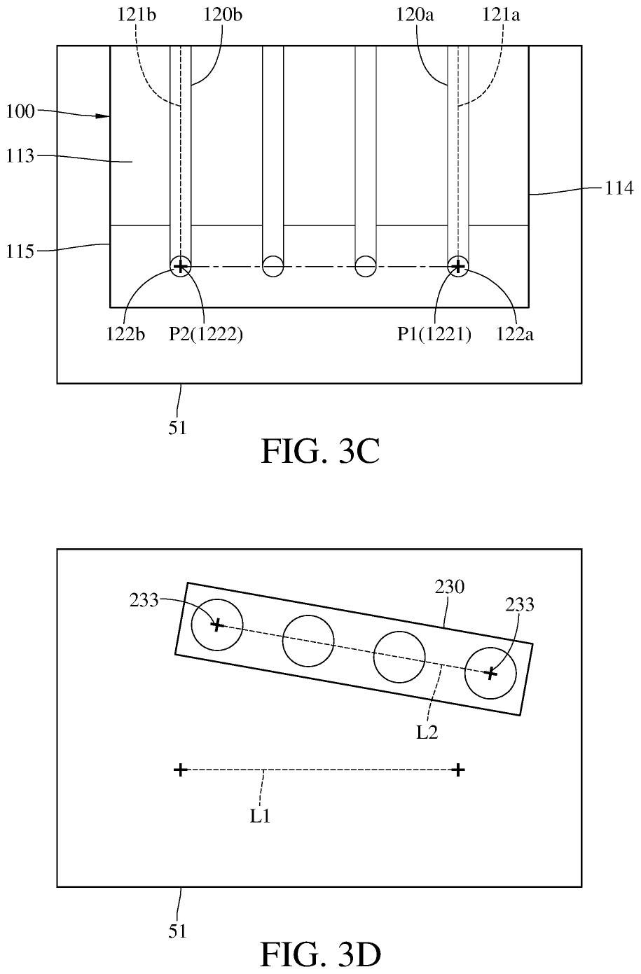

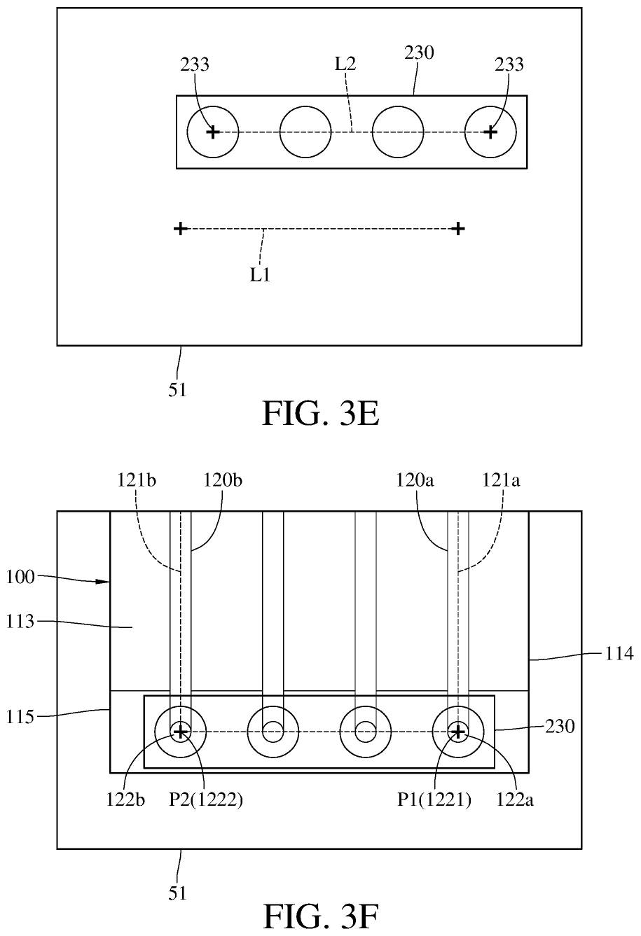

FIG. 3A is a perspective view of a fiber array and a focusing lens according to a second embodiment of the present disclosure. In this embodiment, a focusing lens 230, for example, is an array lens including a bar 231 and multiple lenses 232. The lenses 232 are arranged in linear manner, and a convex surface 2321 of each lens 232 is located opposite to where the bar 231 connects to the bonding surface 113. The focusing lens 230 is configured to be bonded with the fiber array 110 in FIG. 2A. The refractive index of the focusing lens 230 is larger than the refractive index of the fiber array 110. Specifically, the refractive index of the focusing lens 230 is 3.5 in this embodiment.

In the second embodiment, a method of bonding the focusing lens 230 with the fiber array 110 is basically similar to the method disclosed in the first embodiment. FIG. 3C to FIG. 3F are schematic views of bonding the focusing lens in FIG. 3A with a fiber array by using the apparatus in FIG. 1. In this embodiment, the method of bonding the focusing lens 230 with the fiber array 110 includes steps S210 through S260.

Firstly, in the step 210, both a projection P1 of the core end facet 122a of the first optical fiber 120a and a projection P2 of the core end facet 122b of the second optical fiber 120b on the bonding surface 113 of the fiber array 110 is specified by the processing unit to obtain a core end facet information. As shown in FIG. 3C, the fiber array 110 with the optical fibers is supported on the first stage 10 of the apparatus 1 and clamped by the fixture 40. the core end facet 122a of the first optical fiber 120a and the core end facet 122b of the second optical fiber 120b are recognized by the camera 50. In one embodiment, the position of the projection P1 on the bonding surface 113 is specified with a first core pair of reference coordinates, and the position of the projection P1 on the bonding surface 113 is specified with a second core pair of reference coordinates; that is, the core end facet information includes the first core pair of reference coordinates and the second core pair of reference coordinates. These pairs of reference coordinates can be stored in a storage medium or marked on a display showing an image 51 of the camera 50.

In one embodiment, the first core pair of reference coordinates corresponds to a center 1221 of the core end facet 122a of the first optical fiber 120a, and the second core pair of reference coordinates corresponds to a center 1222 of the core end facet 122b of the second optical fiber 120b.

Next, in the step S220, a first line segment L1 between the two projections P1 and P2 (the first core pair of reference coordinates and the second core pair of reference coordinates) is defined. As shown in FIG. 3C, the first line segment L1 is presented in the image 51.

In the step S230, the two optical axes 233 of the focusing lens 230 are recognized by the camera 50. As shown in FIG. 3D, the focusing lens 230 is moved from the second stage 20 to the third stage 30, and both the camera 50 and the pickup component 60 are moved from the first stage 10 to the third stage 30. The camera 50 recognizes the optical axis 233 of a lens 232 close to left end of the focusing lens 230 and another optical axis 233 of a lens 232 close to right end of the focusing lens 230.

In the step S240, a second line segment L2 between the two optical axes 233 of the focusing lens 230 is defined. As shown in FIG. 3D, the two optical axes 233 of the focusing lens 230 could be specified with a first axis pair of reference coordinates and a second axis pair of reference coordinates, respectively. The positions of the two optical axes 233 are specified by the processing unit with the first axis pair of reference coordinates and the second axis pair of reference coordinates, respectively. These pairs of reference coordinates can be stored in the storage medium or marked on the display. The second line segment L2 is defined according to the first axis pair of reference coordinates and the second axis pair of reference coordinates and could be presented the image 51.

In the step S250, the focusing lens 230 is rotated to make the second line segment L2 between the two optical axes 233 of the focusing lens 230 parallel to the first line segment L1 between the first axis pair of reference coordinates and the second axis pair of reference coordinates. As shown in FIG. 3D and FIG. 3E, the line segments L1 and L2 are presented in the image 51. When there is a non-straight angle between extensions of the line segments L1 and L2, the pickup component 60 rotates the focusing lens 230 to make the second line segment L2 parallel to the first line segment L1. In some embodiments, the focusing lens 230 is rotated such that the line second line segment L2 overlaps with the first line segment L1. Then, the pickup component 60 is configured to capture the focusing lens 230 and move it from the third stage 30 to the first stage 10 where the fiber array 110 is located.

In the step S260, an alignment procedure is performed by the pickup component 60 according to the core end facet information to make one optical axis 233 of the focusing lens 230 overlap with the projection P1 of the core end facet 122a of the first optical fiber 120a, and make the other optical axis 233 overlap with the projection P2 of the core end facet 122b of the second optical fiber 120b. As shown in FIG. 3F, the processing unit is configured to check whether the center 1221 of the core end facet 122a and the center 1222 of the core end facet 122b overlaps with the optical axes 233. In one embodiment, the processing unit may check whether the center 1221 of the core end facet 122a and one of the optical axes 233 has identical pair of reference coordinates, and whether the center 1222 of the core end facet 122b has identical pair of reference coordinates with the other optical axis 233. Once there is a deviation between the center 1221 and the optical axis 233 or between the center 1222 and the other optical axis 233, the pickup component 60 is moved to make the centers 1221 and 1222 respectively and simultaneously overlap with the optical axes 233.

Finally, the focusing lens 230 is attached to the bonding surface 113 of the fiber array 110. The detail of attachment can be referred to the step S140 in the first embodiment.

According to the present disclosure, the alignment of the focusing lens with the fiber array is performed according to the projection of the core end facet of the optical fiber on the bonding surface of the fiber array. Thus, the alignment is accomplished by executing only one movement of the focusing lens, thereby resulting in better accuracy of alignment.

The fiber array bonded with the focusing lens is used as an optical component in an optical transceiver. When light in the optical fiber is reflected by the core end facet and passes through the focusing lens, the light converges to a spot to be received by an optical receiver. The focusing lens is favorable for reducing a spot size of light so as to improve coupling efficiency to meet the demand of high communication speed.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. A method of bonding a focusing lens with a fiber array, comprising:
recognizing a core end facet of a first optical fiber disposed on the fiber array by a camera;
specifying a projection of the core end facet of the first optical fiber on a bonding surface of the fiber array by a processing unit to obtain a core end facet information;
performing an alignment procedure by a pickup component according to the core end facet information to make an optical axis of the focusing lens overlap with the projection of the core end facet of the first optical fiber; and
attaching the focusing lens to the bonding surface of the fiber array.

2. The method according to claim 1, wherein the core end facet information comprises a first core pair of reference coordinates corresponding to the projection of the core end facet on the bonding surface.

3. The method according to claim 1, wherein in the alignment procedure, the optical axis of the focusing lens is parallel to a normal direction of the bonding surface of the fiber array.

4. The method according to claim 2, wherein the first core pair of reference coordinates corresponds to a center of the core end facet of the first optical fiber.

5. The method according to claim 2, further comprising:
recognizing a core end facet of a second optical fiber disposed on the fiber array by the camera;
specifying a projection of the core end facet of the second optical fiber on the bonding surface of the fiber array by the processing unit to obtain a second core pair of reference coordinates; and
defining a first line segment between the first core pair of reference coordinates and the second core pair of reference coordinates.
recognizing two optical axes of the focusing lens by the camera; and
rotating the focusing lens to make a second line segment between the two optical axes of the focusing lens parallel to the first line segment.

6. The method according to claim 1, wherein the pickup component is a suction nozzle.

7. The method according to claim 5, wherein a plurality of third optical fibers are arranged between the first optical fiber and the second optical fiber, and the first optical fiber, the second optical fiber and the third optical fibers are all optical fibers disposed on the fiber array.

8. The method according to claim 1, wherein the projection of the core end facet of the first optical fiber on the bonding surface is spaced apart from a periphery of the bonding surface.

9. The method according to claim 1, wherein the focusing lens is either a singlet lens or an array lens.

10. A method of aligning a focusing lens with a fiber array, comprising:
recognizing a core end facet of an optical fiber disposed on the fiber array by a camera;
specifying a projection of the core end facet of the optical fiber on a bonding surface of the fiber array by a processing unit to obtain a core end facet information; and
performing an alignment procedure by a pickup component according to the core end facet information to make an optical axis of the focusing lens overlap with the projection of the core end facet of the optical fiber.
